(19) United States
(12) Patent Application Publication
(10) Pub. No.: US 2017/0242246 A1
(43) Pub. Date: Aug. 24, 2017

(54) HEAD UP DISPLAY APPARATUS AND IMAGE DISPLAY APPARATUS

(71) Applicant: FUJIFILM Corporation, Tokyo (JP)

(72) Inventor: Keisuke HARADA, Saitama-shi (JP)

(73) Assignee: FUJIFILM Corporation, Tokyo (JP)

(21) Appl. No.: 15/429,632

(22) Filed: Feb. 10, 2017

(30) Foreign Application Priority Data
Feb. 22, 2016 (JP) 2016-030707
Dec. 16, 2016 (JP) 2016-244147

(51) Int. Cl. G02B 27/01; B60K 35/00

(52) U.S. Cl. CPC G02B 27/0101; B60K 35/00; G02B 2027/0118; B60K 2350/2052; B60K 2350/2065; B60K 2350/962; B60K 2350/2082

(57) ABSTRACT

An image display apparatus mounted in a head up display apparatus includes: an image display element that outputs display light; a diffusing member that receives the display light at a light receiving surface and outputs the display light as diffused light from a light output surface; and a light deflecting means that deflects the display light output from the image display element, provided between the image display element and the diffusing member. An image display surface of the image display element and the light output surface of the diffusing member are parallel, and the image display element, the diffusing member, and the light deflecting means are arranged in a state such that a line normal to the light output surface of the diffusing member is inclined with respect to the optical axis of the display light after being deflected by the light deflecting means.

### CROSS REFERENCE TO RELATED APPLICATIONS

The present application claims priority under 35 U.S.C. §119 to Japanese Patent Application No. 2016-030707 filed on Feb. 22, 2016 and Japanese Patent Application No. 2016-244147 filed on Dec. 16, 2016. The above applications are hereby expressly incorporated by reference, in their entireties, into the present application.

### BACKGROUND

The present disclosure is related to a head up display apparatus reflects display light of images at an image reflection surface that faces an observer, to display the images to the observer via the image reflection surface as virtual images, as well as to an image display apparatus which is employed in such a head up display apparatus.

Conventionally, head up display apparatuses are known as an apparatus that displays directional commands, warnings, and/or traveling speed, etc. to drivers of automobiles and the like. These head up display apparatuses project virtual images of images to be displayed onto image reflection surfaces of windshields or combiners, etc., to enable drivers to discriminate information necessary to drive automobiles or the like, without averting their eyes from their fields of view. Japanese Unexamined Patent Publication Nos. 2009-115908 and 2014-149405 propose such a head up display apparatus.

### SUMMARY

In the head up display apparatus disclosed in Japanese Unexamined Patent Publication No. 2009-115908, if external light such as sunlight and/or interior light of a vehicle that enters the apparatus is reflected within the apparatus and is irradiated onto an image reflection surface which is displaying virtual images, the display of the virtual image and irradiation of the external light will become overlapped. As a result, the contrast of the virtual images will decrease, and there is a problem that the virtual images will become difficult to view.

This phenomenon will be described in greater detail. In the case that a diffusing member such as a diffuser, for projecting images onto a display surface of image display elements within an apparatus or for temporarily projecting images along the optical path of display light, is provided, external light that enters the apparatus in the direction opposite the optical path of the display light from within the apparatus to an image reflection surface will be mirror reflected at the output surface of the diffusing member. If the optical path of the external light and the optical path of the display light which are output to the exterior of the apparatus overlap, the external light will be overlapped and irradiated onto a virtual image display position of the image reflection surface. As a result, the contrast of virtual images will decrease, and the virtual images will become difficult to view.

In order to solve this problem, Japanese Unexamined Patent Publication No. 2014-149405 provides a diffusing member for temporarily projecting images along the optical path of display light such that a line normal thereto is inclined at a predetermined angle with respect to the optical axis of the display light. Thereby, external light that reaches the output surface of the diffusing member along the optical axis of the display light will be reflected in a direction different from the direction of the optical axis of the display light. As a result, external light which is reflected within the apparatus is not overlapped and irradiated onto a virtual image.

However, there is a problem that trapezoidal distortion will be generated onto the shape of images which are projected onto the diffusing member, if the diffusing member is provided such that the line normal thereto is inclined with respect to the optical axis of display light which is output from image display elements as in the apparatus of Japanese Unexamined Patent Publication No. 2014-149405.

It is possible to correct such trapezoidal distortion by image processing. However, in the case that trapezoidal distortion is corrected by image processing, there are cases in which images to be displayed as virtual images cannot be displayed dot by dot by the image display elements. As a result, there is a problem that a decrease in resolution and a decrease in sharpness will be generated when displaying the virtual images.

The present disclosure has been developed in view of the foregoing circumstances. The present disclosure provides a head up display apparatus which is capable of improving the visibility of virtual images by suppressing mirror reflection of external light that overlaps with the display of the virtual images, without generating distortion in the shapes of images. The present disclosure also provides an image display apparatus for use in this head up display apparatus.

A head up display apparatus of the present disclosure reflects display light of an image at an image reflection surface that faces an observer to display the image to the observer as a virtual image via the image reflection surface, and comprises:

an image display element configured to output the display light;

a diffusing member configured to receive the display light at the side of a light receiving surface and to output the display light as diffused light from the side of a light output surface; and

a light deflecting means configured to deflect the display light which is output from the image display element, provided between the image display element and the diffusing member;

an image display surface of the image display element and the light output surface of the diffusing member being parallel; and

the image display element, the diffusing member, and the light deflecting means being arranged in a state such that a line normal to the light output surface of the diffusing member is inclined with respect to the optical axis of the display light after being deflected by the light deflecting means.

In the head up display of the present disclosure, the light deflecting means may comprise a projection optical system that deflects and projects the display light which is output from the image display element onto the diffusing member, provided between the image display element and the diffusing member, and further, the image display element, the diffusing member, and the projection optical system may be arranged such that the center position of a displayable region of the image display element and the center position of a displayable region of the diffusing member are positioned opposite each other with the optical axis of the projection optical system interposed therebetween.

In addition, the light deflecting means may comprise a projection optical system that deflects and projects the display light which is output from the image display element onto the diffusing member, provided between the image display element and the diffusing member, the projection optical system may form an intermediate image, the optical axis of a front group of the projection optical system toward the image display element from the intermediate image and the optical axis of a rear group of the projection optical system toward the diffusing member from the intermediate image may be different, and further, the image display element, the diffusing member, and the projection optical system may be arranged such that the center position of a displayable region of the image display element and the center position of a displayable region of the diffusing member are positioned opposite each other with the optical axis of the projection optical system interposed therebetween.

Here, the expression “the center position of a displayable region of the Image display element” refers to the center position of an all white image region which is projected onto the diffusing member when the image display element displays an all white image. That is, the expression “the center position of a displayable region of the image display element” refers to a position on the light receiving surface of the diffusing member onto which the center position of the displayable region of the image display element is projected.

In addition, a state in which “the center position of a displayable region of the image display element and the center position of a displayable region of the diffusing member are positioned opposite each other with the optical axis of the projection optical system (the entirety of the projection optical system or the rear group) interposed therebetween” refers to a state in which the above two points are arranged in linearly symmetrical directions having the optical axis of the projection optical system (the entirety of the projection optical system or the rear group) as a reference. The positions at which lines normal to each of the points intersect with the optical axis and/or the distances from each of the points to the optical axis are not necessarily the same for the two points. Note that in the case that a reflecting member such as a mirror or a prism is inserted into the optical path of the display light between the image display element and the diffusing member, the above state refers to that which is achieved when bending of the optical path by the reflecting member is not considered, and the optical path extends linearly.

In addition, the light deflecting means may be a Fresnel lens that deflects the display light, which is received at a light receiving surface, and outputs the display light from a light output surface thereof.

An image display apparatus of the present disclosure is an image display apparatus which is incorporated into a head up display apparatus, and comprises:

an image display element configured to output display light;

a diffusing member configured to receive the display light at the side of a light receiving surface and to output the display light as diffused light from the side of a light output surface; and

a light deflecting means configured to deflect the display light which is output from the image display element, provided between the image display element and the diffusing member;

an image display surface of the image display element and the light output surface of the diffusing member being parallel; and

the image display element, the diffusing member, and the light deflecting means being arranged in a state such that a line normal to the light output surface of the diffusing member is inclined with respect to the optical axis of the display light after being deflected by the light deflecting means.

In the case that a reflecting member such as a mirror or a prism is inserted into the optical path of the display light between the image display element and the diffusing member in the head up display apparatus and the image display apparatus above, the expression “a state such that a line normal to the light output surface of the diffusing member is inclined with respect to the optical axis of the display light after being deflected by the light deflecting means” refers to that which is achieved when bending of the optical path by the reflecting member is not considered, and the optical path extends linearly.

The head up display apparatus and the image display apparatus of the present disclosure comprise the image display element configured to output display light; the diffusing member configured to receive the display light at the side of a light receiving surface and to output the display light as diffused light from the side of a light output surface; and the light deflecting means configured to deflect the display light which is output from the image display element, provided between the image display element and the diffusing member. The image display surface of the image display element and the light output surface of the diffusing member are parallel, and the image display element, the diffusing member, and the light deflecting means are arranged in a state such that a line normal to the light output surface of the diffusing member is inclined with respect to the optical axis of the display light after being deflected by the light deflecting means. Therefore, mirror reflection of external light that overlaps with virtual display can be suppressed without generating distortion in image shapes. As a result, the head up display and the image display apparatus which is employed in the head up display can improve the visibility of virtual images.

### BRIEF DESCRIPTION OF THE DRAWINGS

FIG. 1 is a schematic diagram that illustrates the driver's seat of an automobile in which a head up display apparatus according to a first embodiment of the present disclosure is mounted.

FIG. 2 is a schematic diagram that illustrates the configuration of the head up display apparatus of FIG. 1.

FIG. 3 is a schematic diagram that illustrates the configuration of a projection unit of the head up display apparatus of FIG. 1.

FIG. 4 is a schematic diagram that illustrates the configuration of a head up display apparatus according to a second embodiment of the present disclosure.

FIG. 5 is a schematic diagram of an image display apparatus of the head up display apparatus of FIG. 4 as viewed from a different direction.

FIG. 6 is a schematic diagram that illustrates the configuration of a head up display apparatus according to a third embodiment of the present disclosure.

FIG. 7 is a schematic diagram that illustrates the configuration of a projection unit of the head up display apparatus of FIG. 6.

FIG. 8 is a schematic diagram that illustrates the configuration of a head up display apparatus according to another embodiment of the present disclosure.

### DETAILED DESCRIPTION OF THE PREFERRED EMBODIMENTS

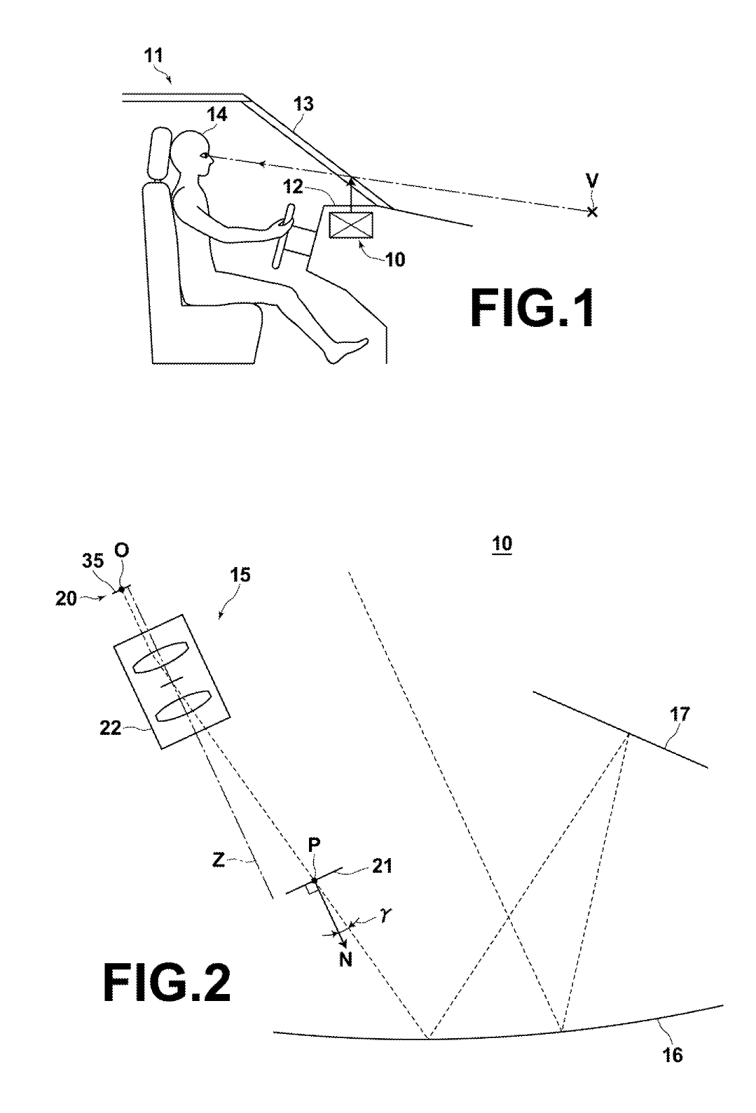

Hereinafter, an embodiment of the present disclosure will be described in detail with reference to the attached drawings. FIG. 1 is a schematic diagram that illustrates the driver's seat of an automobile in which a head up display apparatus according to an embodiment of the present disclosure is mounted. FIG. 2 is a schematic diagram that illustrates the configuration of the head up display apparatus.

As illustrated in FIG. 1, the head up display apparatus 10 of the present embodiment is provided within the dashboard 12 of an automobile 11, causes an image that represents information such as speed of travel which is output from within the apparatus to be reflected by a front windshield (image reflection surface) 13, magnifies and displays the reflected image in front of a driver (observer) 14 through the windshield 13 as a virtual image V.

As illustrated in FIG. 2, the head up display apparatus 10 includes an image display apparatus 15 for displaying the virtual image V, a concave mirror 16, and a planar mirror 17. Display light which is output from the image display apparatus 15 is reflected by the concave mirror 16, the planar mirror 17, and the concave mirror 16, in this order, and reaches the front windshield 13 after passing between the image display apparatus 15 and the planar mirror 17.

The image display apparatus 15 is equipped with a projection unit 20 that includes a DMD (Digital Micromirror Device) element 35 as an image display element that outputs the display light, a diffuser (diffusing member) 21 that outputs the display light, which is received at the side of a light receiving surface, as diffused light from the side of a light output surface, and a projection optical system (light deflecting means) 22 provided between the DMD element 35 and the diffuser 21, that deflects the display light which is output from the DMD element 31. The image display surfaces of the DMD element 35 and the light output surface of the diffuser 21 are parallel, and the DMD element 35, the diffuser 21, and the projection optical system 22 are arranged in a state in which a line N normal to the light output surface of the diffuser 21 is inclined with respect to the optical axis of the display light after being deflected by the projection optical system 22.

Here, the expression “image display surface of the DMD element 35 and the light output surface of the diffuser 21 are parallel, and the DMD element 35, the diffuser 21, and the projection optical system 22 are arranged in a state in which a line N normal to the light output surface of the diffuser 21 is inclined with respect to the optical axis of the display light after being deflected by the projection optical system 22” means that in the case that a reflecting member such as a mirror or a prism is inserted into the optical path of the display light between the DMD element 35 and the diffuser 21, the above state refers to that which is achieved when bending of the optical path by the reflecting member is not considered, and the optical path extends linearly.

In the present embodiment, the DMD element 35 is incorporated into the projection unit 20, to be described later. A reflecting member within the projection unit 20 is configured to bend the optical path of the display light which is output from the DMD element 35. To facilitate understanding of the configuration, FIG. 2 illustrates the positions of the DMD element 35 in the case that bending of the optical path by the reflecting member is not taken into consideration, and the optical path which is bent by the reflecting member is not bent, but extends linearly.

In the case that the virtual image V is projected without passing through the diffuser 21, the sharpness of the virtual image V will become greater. However, the range of pupil positions at which the virtual image can be clearly discriminated will be limited to an extremely narrow range. Therefore, there is a possibility that visibility will decrease if the head of the driver 14 moves with respect to the windshield 13. However, by projecting the virtual image V through a diffusing member such as the diffuser 21, the range of pupil positions in which the virtual image V can be clearly discriminated can be expanded.

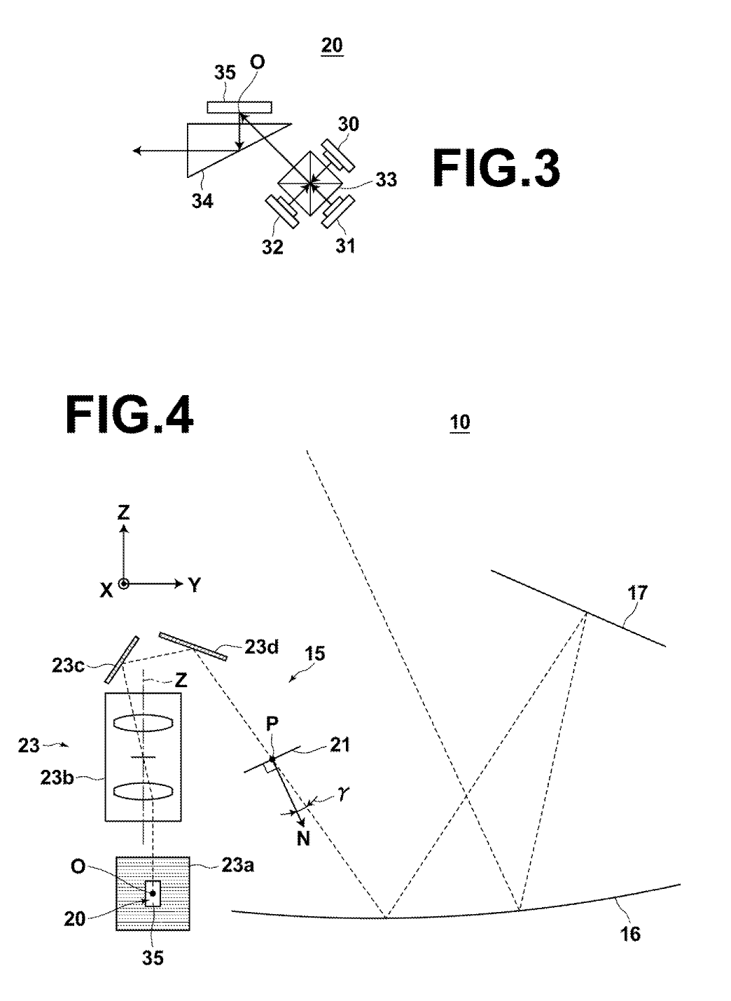

As illustrated in FIG. 3, the projection unit 20 is constituted by: a red (R) LED light source 30, a green (G) LED light source 31, a blue (B) LED light source 32; a dichroic prism 33 that combines light output by these light sources; the DMD (Digital Micromirror Device) elements 35; and a TIR (Total Internal Reflection) prism 36 that guides RGB light output from the dichroic prism 33 to the DMD element 35 and guides the display light reflected by the DMD element 35 to the projection optical system 22.

The projection optical system 22 deflects the display light which is output from the DMD element 35 and projects the deflected display light onto the diffuser 21. By arranging the projection optical system (light deflecting means) 22 such that the optical axis Z thereof is parallel to the optical axis of the display light immediately after being output from the DMD element 35 (the optical axis prior to being deflected by the light deflecting means), distortion in image shape can be minimized when the display light is projected onto the diffuser (diffusing member) 21. Therefore, the projection optical system 22 is arranged such that the optical axis Z thereof is parallel to the optical axis of the display light immediately after being output from the DMD element 35, and such that the center position O of a displayable region of the DMD element 35 and the center position P of a displayable region of the diffuser 21 are opposite each other with the optical axis Z of the projection optical system 22 interposed therebetween. By adopting such an arrangement, it is possible for the projection optical system 22 to deflect the display light which is output from the DMD element 35 toward the diffuser 21 from the DMD element 35 with the optical axis Z interposed therebetween. In addition, distortion of image shape can be prevented from being generated when projecting the display light which is output from the DMD element 35 onto the diffuser 21.

Note that the projection optical system 22 illustrated in FIG. 2 is schematically illustrated, and does not represent the actual positions, shapes, or numbers of lenses and an aperture. With respect to the configuration of the projection optical system 22, any configuration may be adopted as long as it is capable of deflecting the display light which is output from the DMD element 35 and projecting it onto the diffuser 21.

In the head up display 10 which is configured as described above, the line N normal to the light output surface of the diffuser 21 is inclined by an angle denoted as γ in FIG. 2 with respect to the optical axis of the display light after being deflected by the projection optical system 22. Thereby, external light that reaches the light output surface of the diffuser 21 along the optical axis of the display light will be reflected in a direction different from that along the optical axis of the display light. As a result, external light which is reflected within the apparatus can be prevented from becoming irradiated overlapped with the virtual image. Further, the image display surface of the DMD element 35 and the light output surface of the diffuser 21 are parallel. Therefore, distortion will not be generated in the shape of an image which is projected onto the diffuser 21. As a result, the problems of decreases in resolution and sharpness due to correcting the image shape by image processing when displaying the virtual image can be prevented from occurring.

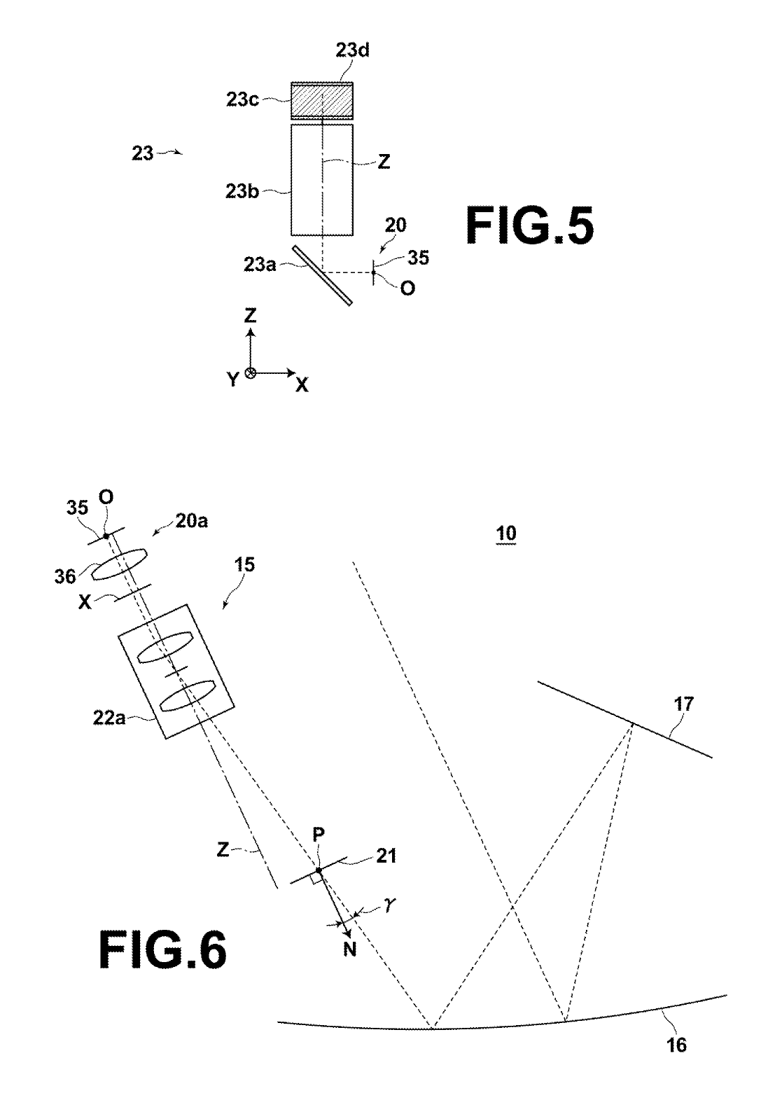

Next, a second embodiment of the present disclosure will be described in detail with reference to the drawings. FIG. 4 is a schematic diagram (a Y-Z plan view) that illustrates the configuration of a head up display apparatus according to the second embodiment of the present disclosure. FIG. 5 is a schematic diagram (an X-Z plan view) of an image display apparatus of the head up display apparatus of FIG. 4 as viewed from a different direction.

The head up display apparatus 10 of the second embodiment only differs from the head up display apparatus 10 of the first embodiment in the configuration within an image display apparatus 15 thereof. Here, descriptions of portions which are the same as those of the head up display apparatus 10 of the first embodiment will be omitted.

As illustrated in FIG. 4, the image display apparatus 15 of the head up display apparatus 10 of the second embodiment is equipped with a projection unit 20 that includes a DMD element 35 that outputs display light, a diffuser 21 that outputs the display light, which is received at the side of a light receiving surface, as diffused light from the side of a light output surface, and a light deflecting means 23 provided between the DMD element 35 and the diffuser 21, that deflects the display light which is output from the DMD element 31. The image display surfaces of the DMD element 35 and the light output surface of the diffuser 21 are parallel, and the DMD element 35, the diffuser 21, and the light deflection means 23 are arranged in a state in which a line N normal to the light output surface of the diffuser 21 is inclined with respect to the optical axis of the display light after being deflected by the light deflecting means 23.

Note that as will be described later, reflecting members (planar mirrors) are inserted in the optical path of the display light between the DMD element 35 and the diffuser 21 in the present embodiment. However, that the “image display surfaces of the DMD element 35 and the light output surface of the diffuser 21 are parallel, and the DMD element 35, the diffuser 21, and the light deflection means 23 are arranged in a state in which a line N normal to the light output surface of the diffuser 21 is inclined with respect to the optical axis of the display light after being deflected by the light deflecting means 23” means that in the case that a reflecting member such as a mirror or a prism is inserted into the optical path of the display light between the DMD element 35 and the diffuser 21, the above state refers to that which is achieved when bending of the optical path by the reflecting member is not considered, and the optical path extends linearly.

In the present embodiment, the DMD element 35 is incorporated into the projection unit 20, to be described later. A reflecting member within the projection unit 20 is configured to bend the optical path of the display light which is output from the DMD element 35. To facilitate understanding of the configuration, FIG. 4 and FIG. 5 illustrate the positions of the DMD element 35 in the case that bending of the optical path by the reflecting member is not taken into consideration, and the optical path which is bent by the reflecting member is not bent, but extends linearly.

As illustrated in FIG. 4 and FIG. 5, the light deflecting means 23 is constituted by, in order from the side of the projection unit 20, a planar mirror 23a, a projection optical system 23b, a planar mirror 23c, and a planar mirror 23d.

By combining the projection optical system 23b and the three planar mirrors 23a, 23c, and 23d in this manner, the degree of freedom in the placement of the projection unit 20 can be improved. Further, providing the projection unit 20 toward the concave mirror 16 with the optical axis Z of the projection optical system 23b as a reference contributes to the miniaturization of the head up display apparatus 10 as a whole.

Note that the number of planar mirrors to be combined with the projection optical system is not limited to three, and one or a plurality of planar mirrors may be employed. In addition, the arrangement position of the projection unit 20 is also not limited to that described above.

The configuration of the second embodiment also exhibits similar advantageous effects as those exhibited by the first embodiment.

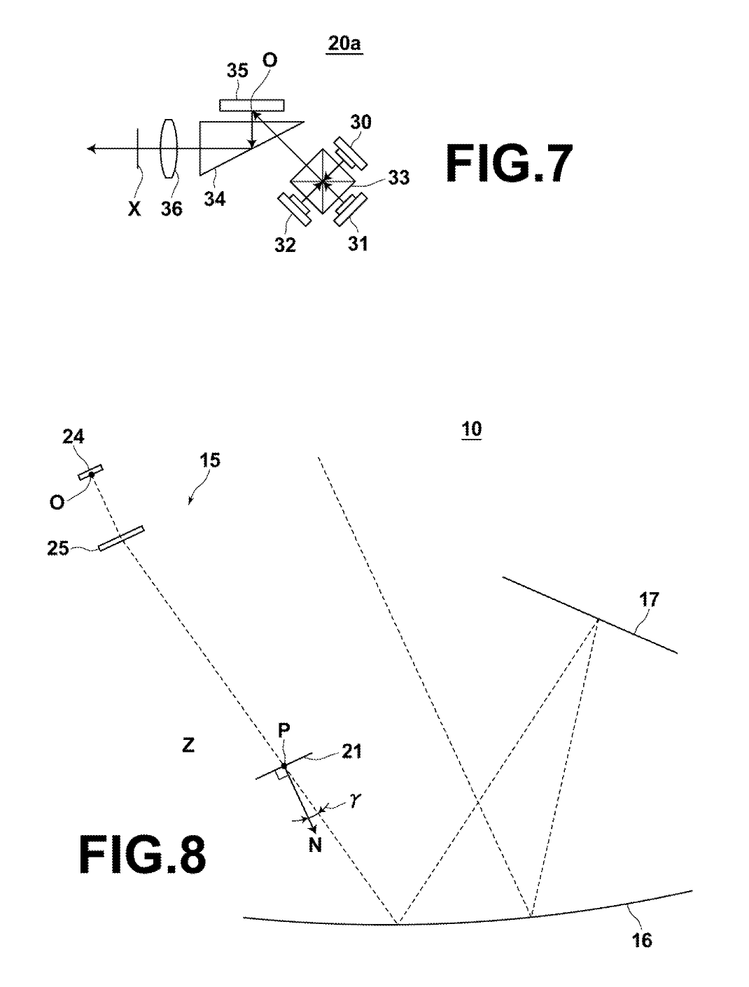

Next, a third embodiment of the present disclosure will be described in detail with reference to the drawings. FIG. 6 is a schematic diagram that illustrates the configuration of a head up display apparatus according to the third embodiment of the present disclosure. FIG. 7 is a schematic diagram that illustrates the configuration of a projection unit of the head up display apparatus of FIG. 6.

The head up display apparatus 10 of the third embodiment only differs from the head up display apparatus 10 of the first embodiment in the configurations of a projection unit and a projection optical system. Here, descriptions of portions which are the same as those of the head up display apparatus 10 of the first embodiment will be omitted.

As illustrated in FIG. 6, the projection optical system of the present embodiment forms an intermediate image X, and is divided into a front group 36 toward the DMD element (image display element) 35 from the intermediate image X and a rear group 22a toward the diffuser (diffusing member) 21 from the intermediate image X. The optical axes of the front group 36 and the rear group 22a are different. In addition, the center position O of a displayable region of the DMD element 35 and the center position P of a displayable region of the diffuser 21 are positioned opposite each other with the optical axis of the rear group 22a of the projection optical system interposed therebetween.

In addition, as illustrated in FIG. 7, the projection unit 20a of the present embodiment differs from the projection unit 20 of the first embodiment illustrated in FIG. 3 in that the front group 36 is provided toward the front of the TIR prism 34.

Note that the front group 36 and the rear group 22a of the projection optical system illustrated in FIG. 6 and FIG. 7 are schematically illustrated, and do not represent the actual positions, shapes, or numbers of lenses, an aperture, or the intermediate image. With respect to these configurations, any configuration may be adopted as long as it is capable of forming an intermediate image within the projection optical system, deflecting the display light which is output from the DMD element 35, and projecting it onto the diffuser 21.

The configuration of the third embodiment also exhibits similar advantageous effects as those exhibited by the first embodiment. In addition, advantageous effects which are unique to the present embodiment are also exhibited.

If light is output by setting a portion of the lenses of the projection optical system between the DMD element (image display element) 35 and the diffuser (diffusing member) 21 to be eccentric (optical axis shifting or lens tilting), normally, an image which is projected onto the diffuser 21 will be asymmetrically distorted, and the influence on aberrations such as field curvature will increase. Therefore, such eccentricities are not preferable in projection optical systems, in which it is desired for distortion in projected images to be small. In addition, use of rotationally asymmetrical lenses and free curved surface lenses in projection optical systems to avoid such a problem is not preferable, as such lenses will increase costs.

In the case that a projection optical system between the DMD element (image display element) 35 and the diffuser (diffusing member) 21 is divided into two groups, which are the front group 36 provided within the projection unit 20a that includes the DMD element 35 and the rear group 22a at a rear stage, and the optical axes of the two groups are shifted as in the present embodiment, a projected image can be caused to be symmetrical similarly to a case in which only the DMD element 35 is set eccentric with respect to the optical axis of the projection optical system, by configuring the projection optical system to form the intermediate image X between the front group 36 and the rear group 22a. As a result, the influence which is exerted on aberrations can be sufficiently decreased.

In addition, by forming the intermediate image X within the projection optical system, the diameters of the lenses within the rear group 22a, which is beyond the intermediate image X, can be decreased for a same wide angle. Enlargement of display sizes of virtual images is desired in head up display apparatuses. Accompanying this demand, there is also a desire for a projection optical system which is provided at the front surface of the DMD element (image display element) 35 to have a wide angle. For this reason, in the case that a projection optical system is divided into two groups, the projection optical system can be miniaturized while maintaining a desired level of wide angle performance, by forming the intermediate image X within the projection optical system and dividing the projection optical system into the front group 36 and the rear group 22a at either side of the intermediate image X. Such a configuration contributes to miniaturization of the apparatus as a whole.

The present disclosure has been described above with reference to the embodiments and examples. However, the present disclosure is not limited to the embodiments and examples described above, and various modifications are possible.

For example, the image display element may not be that which is incorporated into a projection unit as those described above. An image display element 24 such as an organic EL (Electro Luminescence) panel or a direct view type LCD (Liquid Crystal Display) panel may be employed to directly output display light, as illustrated in FIG. 8.

In addition, a Fresnel lens 25 may be employed instead of the projection optical systems described above as the light deflecting means, as illustrated in FIG. 8. Note that in the case that the Fresnel lens 25 is employed as the light deflecting means, distortion in image shape when display light which is output from the image display element 24 is projected onto the diffuser 21 can be minimized, by arranging the lens surface of the Fresnel lens 25 to e parallel to an image display surface of the image display element 24.

What is claimed is:

1. A head up display apparatus that reflects display light of an image at an image reflection surface that faces an observer to display the image to the observer as a virtual image via the image reflection surface, and comprises:
an image display element configured to output the display light;
a diffusing member configured to receive the display light at the side of a light receiving surface and to output the display light as diffused light from the side of a light output surface; and
a light deflecting means configured to deflect the display light which is output from the image display element, provided between the image display element and the diffusing member;
an image display surface of the image display element and the light output surface of the diffusing member being parallel; and
the image display element, the diffusing member, and the light deflecting means being arranged in a state such that a line normal to the light output surface of the diffusing member is inclined with respect to the optical axis of the display light after being deflected by the light deflecting means.

2. A head up display as defined in claim 1, wherein:
the light deflecting means comprises a projection optical system that deflects and projects the display light which is output from the image display element onto the diffusing member, provided between the image display element and the diffusing member; and
the image display element, the diffusing member, and the projection optical system may be arranged such that the center position of a displayable region of the image display element and the center position of a displayable region of the diffusing member are positioned opposite each other with the optical axis of the projection optical system interposed therebetween.

3. A head up display as defined in claim 1, wherein:
the light deflecting means comprises a projection optical system that deflects and projects the display light which is output from the image display element onto the diffusing member, provided between the image display element and the diffusing member;
the projection optical system forms an intermediate image;
the optical axis of a front group of the projection optical system toward the image display element from the intermediate image and the optical axis of a rear group of the projection optical system toward the diffusing member from the intermediate image are different; and
the image display element, the diffusing member, and the projection optical system may be arranged such that the center position of a displayable region of the image display element and the center position of a displayable region of the diffusing member are positioned opposite each other with the optical axis of the projection optical system interposed therebetween.

4. A head up display apparatus as defined in claim 1, wherein:
the light deflecting means is a Fresnel lens that deflects the display light, which is received at the side of a light receiving surface, and outputs the deflected display light from the side of a light output surface.

5. An image display which is incorporated into a head up display apparatus, comprising:
an image display element configured to output display light;
a diffusing member configured to receive the display light at the side of a light receiving surface and to output the display light as diffused light from the side of a light output surface; and
a light deflecting means configured to deflect the display light which is output from the image display element, provided between the image display element and the diffusing member;
an image display surface of the image display element and the light output surface of the diffusing member being parallel; and
the image display element, the diffusing member, and the light deflecting means being arranged in a state such that a line normal to the light output surface of the diffusing member is inclined with respect to the optical axis of the display light after being deflected by the light deflecting means.
